(19) United States
(12) Patent Application Publication
(10) Pub. No.: US 2025/0359702 A1
(43) Pub. Date: Nov. 27, 2025

(54) GRIDDLE FOR A COOKING STATION

(71) Applicant: ACEWILL CORPORATION, Apia (WS)

(72) Inventor: Kiosky Chung, Taichung (TW)

(21) Appl. No.: 18/673,330

(22) Filed: May 24, 2024

(51) Int. Cl. A47J 37/06

(52) U.S. Cl. CPC A47J 37/0682

(57) ABSTRACT

A griddle includes a plate formed with a raised portion to be heated by a burner. The raised portion of the plate includes a convex upper face and a concave lower face. The convex upper face is formed with a flat middle portion. The concave lower face is formed with a flat middle portion.

### BACKGROUND OF INVENTION

### 1. Field of Invention

The present invention relates to a cooking station and, more particularly, to a griddle for a cooking station.

### 2. Related Prior Art

Patent Application Publication No. US20220338673A1 discloses an X-shaped structure attached to a lower face of a griddle. The X-shaped structure is intended to reinforce the griddle. In use, a central portion of the griddle is located above a burner of a cooking station. Inevitably, the burner heats the central portion of the griddle more than the remaining portion of the griddle. The central portion of the griddle expands more than the remaining portion of the griddle. There is considerable thermal stress in the griddle.

The present invention is therefore intended to obviate or at least alleviate the problems encountered in the prior art.

### SUMMARY OF INVENTION

It is the primary objective of the present invention to provide a reliable griddle for a cooking station.

To achieve the foregoing objective, the griddle includes a plate formed with a raised portion to be heated by a burner. The raised portion of the plate includes a convex upper face and a concave lower face.

In another aspect, the convex upper face is formed with a flat middle portion.

In another aspect, the concave lower face is formed with a flat middle portion.

In another aspect, the griddle further includes a continuous wall extending around the plate.

Other objectives, advantages and features of the present invention will be apparent from the following description referring to the attached drawings.

### BRIEF DESCRIPTION OF DRAWINGS

The present invention will be described via detailed illustration of two embodiments referring to the drawings wherein:

FIG. 1 is a perspective view of a griddle according to the first embodiment of the present invention;

FIG. 2 is another perspective view of the griddle shown in FIG. 1;

FIG. 3 is a cross-sectional view of the griddle shown in FIG. 1;

FIG. 4 is an enlarged partial view of the griddle shown in FIG. 3;

FIG. 5 is a perspective view of a griddle according to the second embodiment of the present invention; and

FIG. 6 is a top view of the griddle shown in FIG. 5.

### DETAILED DESCRIPTION OF EMBODIMENTS

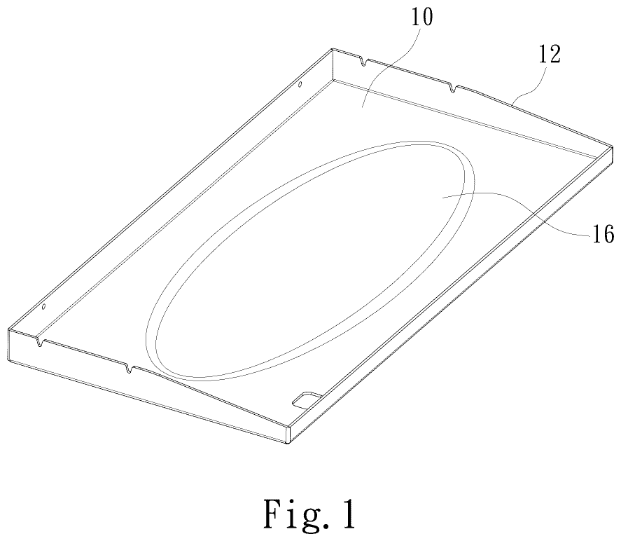

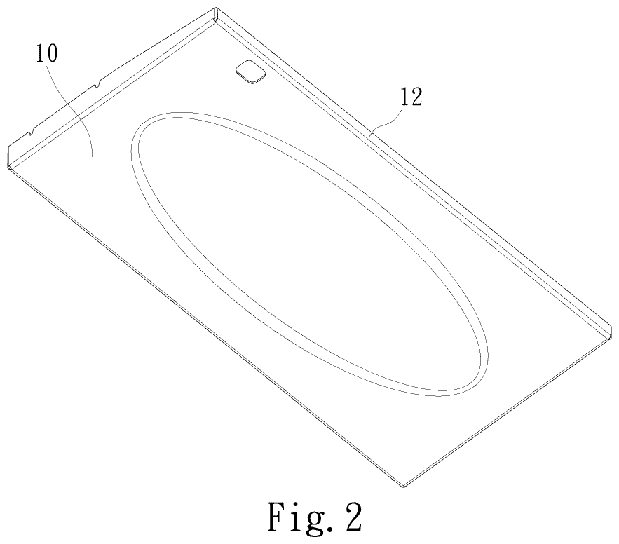

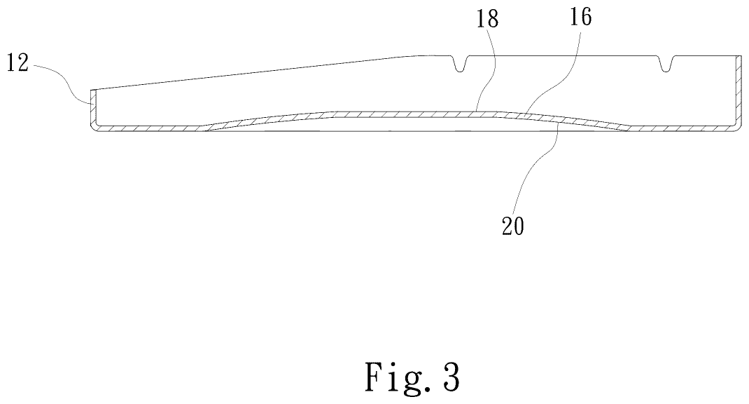

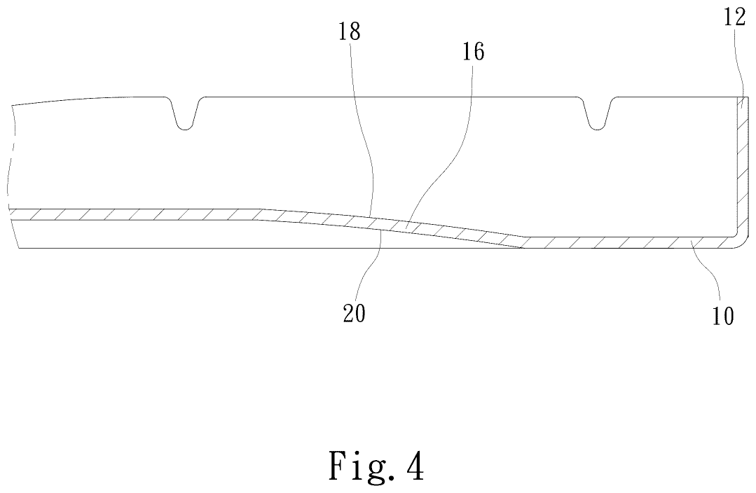

Referring to FIGS. 1 through 4, a griddle includes a plate 10 and a continuous wall 12 according to a first embodiment of the present invention. The plate 10 includes a raised central portion 16. In detail, the raised central portion 16 includes a convex upper face 18 and a concave lower face 20. The convex upper face 18 includes a flat middle portion. The concave lower face 20 includes a flat middle top corresponding to the flat middle portion of the convex upper face 18. The raised central portion 16 is preferably an oval portion.

The continuous wall 12 extends around the plate 10. The continuous wall 12 rises from the plate 10. The continuous wall 12 is operable to keep food on the plate 10. The continuous wall 12 is preferably made in one piece with the plate 10 by pressing or molding. Alternatively, the continuous wall 12 is connected to the plate 10 by welding.

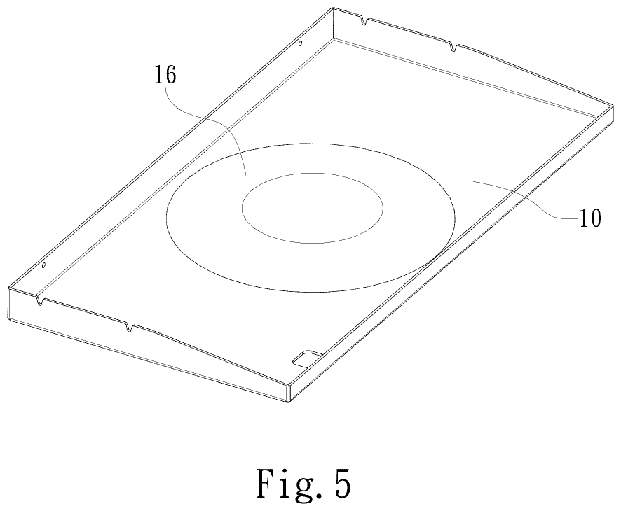

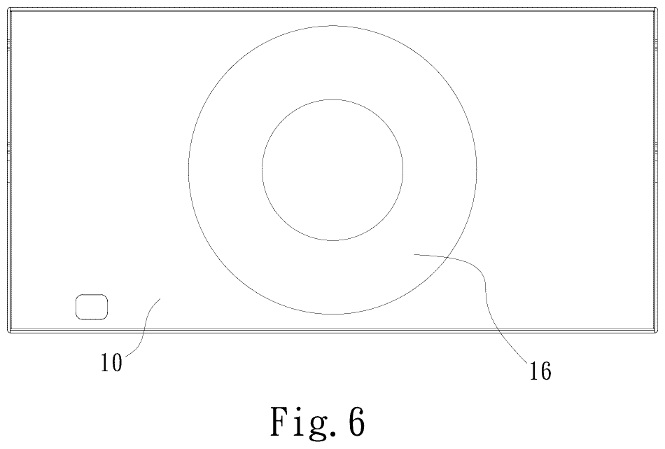

Referring to FIGS. 5 and 6, there is a griddle according to a second embodiment of the present invention. The second embodiment is identical to the first embodiment except for the raised central portion 16 is a circular portion instead of the oval portion.

In use, the griddle is located on a cooking station (not shown) so that the raised central portion 16 of the plate 10 is located above a burner (not shown) of the cooking station. Inevitably, the burner heats the raised central portion 16 of the plate 10 more than the remaining portion of the plate 10 so that the raised central portion 16 of the plate 10 expands more than the remaining portion of the plate 10. Advantageously, the raised central portion 16 of the plate 10 is a prestressed portion for minimizing thermal stress in the entire plate 10.

The present invention has been described via the illustration of the embodiments. Those skilled in the art can derive variations from the embodiments without departing from the scope of the present invention. Therefore, the embodiments shall not limit the scope of the present invention defined in the claims.

1. A griddle comprising:
a plate formed with a raised portion to be heated by a burner, wherein the raised portion of the plate comprises a convex upper face and a concave lower face; and
a continuous wall extending around the plate.

2. The griddle according to claim 1, wherein the convex upper face comprises a flat middle portion.

3. The griddle according to claim 1, wherein the concave lower face comprises a flat middle portion.
